(19) United States
(12) Patent Application Publication
(10) Pub. No.: US 2026/0197556 A1
(43) Pub. Date: Jul. 9, 2026

(54) METHODS AND APPARATUS FOR AUTOFOCUS FOR IMAGE CAPTURE SYSTEMS

(71) Applicant: Intel Corporation, Santa Clara, CA (US)

(72) Inventors: Yuanyuan Wang, Beijing (CN); Fuwen Li, Beijing (CN); Hongjiang Zheng, Beijing (CN); Zhaowei Shu, Beijing (CN)

(73) Assignee: Intel Corporation, Santa Clara, CA (US)

(21) Appl. No.: 19/130,113

(22) PCT Filed: Dec. 14, 2022
(86) PCT No.: PCT/CN2022/138978

§ 371 Date: May 14, 2025

(51) Int. Cl. H04N 23/67; G06V 40/16; H04N 23/611

(52) U.S. Cl. CPC H04N 23/675; G06V 40/166; G06V 40/171; H04N 23/611; H04N 23/672; H04N 23/673; H04N 23/676

(57) ABSTRACT

Methods, apparatus, systems, and articles of manufacture are disclosed to control autofocus of an image capture device. An example method includes obtaining face information including a current face region from a face detection library, calculating a region difference metric between the current face region and a reference face region, extracting statistics of the current face region, controlling at least one of a scene change judgement or a dead zone to determine whether to trigger autofocus iterations, performing an autofocus iteration with lens movement controlled based on the region difference metric; and saving an in-focus face region resulting from the autofocus iteration as the reference face region.

### FIELD OF THE DISCLOSURE

This disclosure relates generally to image capture systems and, more particularly, to methods and apparatus for autofocus for image capture systems.

### BACKGROUND

Many image capture systems utilize a lens that may be moved to adjust the captured image. Autofocus (AF) aims to ensure that a subject of the image is sharp within the view scope. Some autofocus systems detect subject distance from the camera based on some information regarding the lens position, then utilize an electronic motor to adjust the focal distance of the lens achieving accurate focus position.

Autofocus methods may be active or passive. For example, passive autofocus can be performed using contrast detection (CAF) or phase detection (PDAF) methods. Alternatively, active autofocus methods may use techniques to measure a distance to a subject (e.g., may shine a light on the target and measure the light bounced off the target to measure distance).

### BRIEF DESCRIPTION OF THE DRAWINGS

FIG. 1 is a block diagram of an example environment in which autofocus circuitry operates to facilitate focusing an image capture system.

FIG. 2 is a block diagram of an example implementation of the autofocus circuitry of FIG. 1.

FIGS. 3-5 illustrate images that may be focused and captured by a camera.

FIG. 6 is an example graph illustrating an example approach for controlling autofocus.

FIGS. 7-10 are flowcharts representative of example machine readable instructions and/or example operations that may be executed by example processor circuitry to implement the autofocus circuitry of FIG. 2 to implement improved autofocus functionality.

FIG. 11 is a block diagram of an example processing platform including processor circuitry structured to execute the example machine readable instructions and/or the example operations of FIG. 7-10 to implement the autofocus circuitry of FIG. 2.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 7-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Image capture systems are widely used in scene with faces such as taking photos for portrait, surveillance, online teaching, and video conference. Such usage leads to new user preferences for autofocus, auto exposure and auto white balance (3 A) functions of such image capture systems. For autofocus, when a target face is moving, a user would prefer both a well-focused face and stability of focus behavior. Traditional autofocus will be triggered when there is some face movement no matter if there is a depth distance change or not, which leads to repeated focus oscillation. Such repeated autofocus behavior should be avoided.

For example, if the person is conducting a video conference, they may cause some face movement (e.g., nodding or shaking the head, turning the face to grab a cup of coffee with slight depth change, etc.). Such small movements could trigger scene instability, which is caused by lens movement back and forth due to repeatedly triggering autofocus.

Methods and apparatus disclosed herein introduce an improved autofocus mechanism to produce a well-focused subject (e.g., a face) without repeated autofocus response. Methods and apparatus disclosed herein can be utilized with a variety of autofocus techniques such as contrast autofocus (CAF) and phase difference autofocus (PDAF).

According to some examples disclosed herein, an image capture sensor outputs raw frames to an image signal processing hardware (ISP). The example ISP outputs autofocus statistics for each of the raw frames. An autofocus circuitry will analyze the statistics for a region of interest(s) (e.g., a face region based on a face detection library) and outputs a new lens position for a next iteration. After several iterations, the autofocus circuitry outputs a final lens position for a determined best image focus.

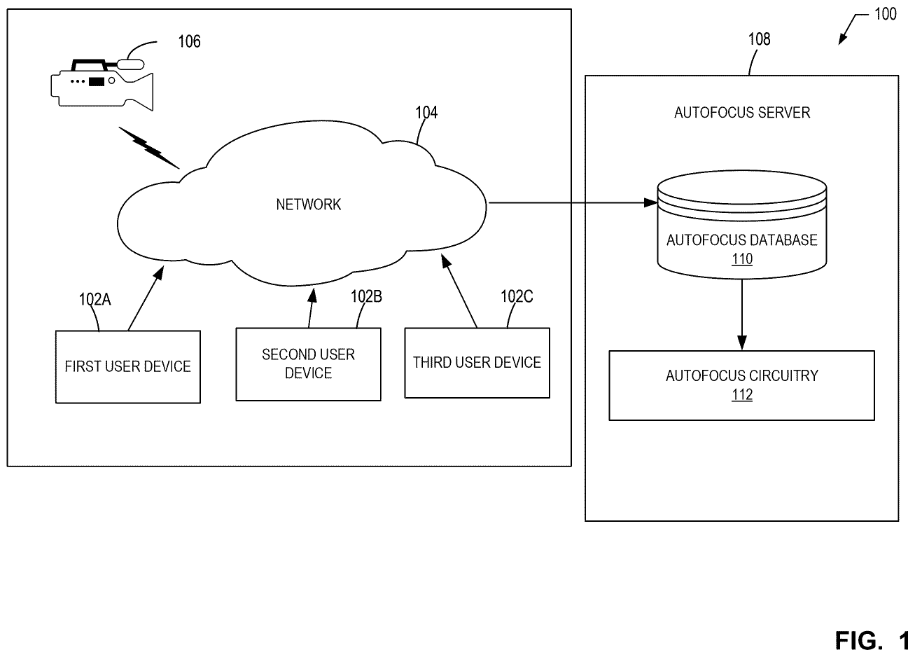

FIG. 1 is a block diagram of an example environment 100 in which autofocus circuitry 112 operates to facilitate focusing an image capture system.

The example environment 100 includes an example first user device 102A, an example second user device 102B, an example third user device 102C, an example network 104, an example camera 106, and an example autofocus server 108. According to the illustrated example, each of the first user device 102A, the second user device 102B, the third user device 102C, and the camera 106 include an image capture system that includes at least one lens that can be moved to focus an image for an image sensor. According to the illustrated example, the autofocus server 108 analyzes data associated with one or more images captured by the image sensors to control the lens to facilitate focusing the image. While the autofocus server 108 is illustrated as a central device that provides focus control for multiple devices, the components of the autofocus server 108 may be included in one or more of the first user device 102A, the second user device 102B, the third user device 102C, and/or the camera 106 to provide local autofocus control.

The first user device 102A, the second user device 102B, and the third user device 102C may be any type of device that includes an image sensor and/or may be coupled with an image sensor. For example, the devices 102A, 102B, 102C may be a mobile phone, a laptop computer, a desktop computer, a surveillance system controller, etc. The image sensor of the devices 102A, 102B, 102C may be internal to the device or external (e.g., a camera attached via a cable, network, wireless network, etc. to the device). The devices 102A, 102B, 102C may include any number of internal and/or external image sensors.

According to the illustrated example, the devices 102A, 102B, 102C are coupled to the autofocus server 108 via the network 104. According to the illustrated example, the network 104 is a local bus connecting a respective instance of the autofocus server 108 to the devices 102A, 102B, 102C. For example, such a bus may be direct connection between one of the devices 102A, 102B, 102C and a respective instance of the autofocus server 108. Alternatively, the network 104 may be any other type of network such as a local network, a wide area network, a wireless network, a wired network, a short-range network, etc.

The example camera 106 is a dedicated image capture device such as, for example, a surveillance camera. According to the illustrated example, the camera 106 is coupled to the autofocus server 108 via the network 104. Alternatively, the functionality (e.g., the circuitry) of the autofocus server 108 may be integrated into the camera 106 (e.g., contained within the casing of the camera 106, coupled to a circuit board of the camera 106, etc.). The image capture components of the example camera 106 include a lens that can be adjusted to control the focus of the camera 106 based on information from the autofocus server 108.

The autofocus server 108 of the illustrated example includes an example autofocus database 110 and an example autofocus circuitry 112. Information received from the example user devices 102A, 102B, 102C and/or the camera 106 is stored in the autofocus database 110 and processed by the autofocus circuitry 112 to determine focus settings (e.g., lens adjustments) to be applied by the devices 102A, 102B, 102C and/or the camera 106.

The example autofocus database 110 of the illustrated example is a data structure for storing information about an environment experienced by the example devices 102A, 102B, 102C and/or the camera 106. According to the illustrated example, the environment information is raw frames captured by the devices 102A, 102B, 102C, and/or the camera 106. Alternatively, the environment information may include any other type or format of data about an environment such as, for example, information about a location of a detected object in an image (e.g., a dedicated face region), information about a lens position, information about a focus setting, information about a camera setting, lighting information, information about a state of an environment (e.g., an indication of a detected scene change), etc. The example autofocus database 110 additionally stores a face detection library to facilitate the detection of a face(s) in the image data (e.g., image data that has been processed by an image signal processor). Alternatively, if face detection is performed by another device (e.g., performed by the devices 102A, 102B, 102C and/or camera 106), the autofocus database 110 may not store the face detection library.

The autofocus database 110 of the illustrated example is a database stored in a memory. Alternatively, the autofocus database 110 may be any number and/or type of data structure stored in any number and/or type of storage device. For example, the raw image data may be stored in a cache memory and the face detection library may be stored in a file.

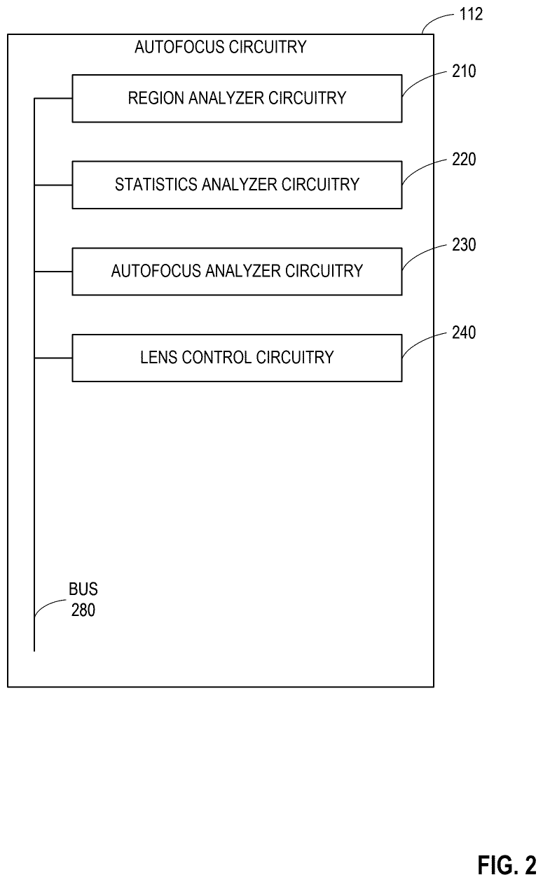

The autofocus circuitry 112 analyzes the environment information stored in the example autofocus database 110 to determine focus adjustments to be conveyed to the devices 102A, 102B, 102C and/or the camera 106 to cause adjustments to lens positions in attempt to bring an image into focus. For example, the autofocus circuitry 112 may direct adjustments to lens position to cause an image capture device to focus on a face that is detected in an image. An example implementation of the autofocus circuitry 112 is described in conjunction with FIG. 2.

In an example operation, the devices 102A, 102B, 102C and/or camera 106 transmit raw image frames to the autofocus database 110. The example autofocus circuitry 112 analyzes the raw images to determine autofocus statistics for each frame. The example autofocus circuitry 112 analyzes the statistics for regions of interest (e.g., a face detected based on a face detection library) and outputs a new lens position to the respective device 102A, 102B, 102C and/or camera 106. This process continues with adjusting lens position until the image is determined to be in focus and the process can stop until a detected scene change causes the process to be restarted.

FIG. 2 is a block diagram of an example implementation of the autofocus circuitry 112 to control lens positions of an image capture device to focus the image capture device on a region. The autofocus circuitry 112 of FIG. 2 may be instantiated (e.g., creating an instance of, bring into being for any length of time, materialize, implement, etc.) by processor circuitry such as a central processing unit executing instructions. Additionally or alternatively, the autofocus circuitry 112 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example autofocus circuitry 112 of FIG. 2 includes an example region analyzer circuitry 210, an example statistics analyzer circuitry 220, an example autofocus analyzer circuitry 230, an example lens control circuitry 240, and an example bus 280 to couple the components.

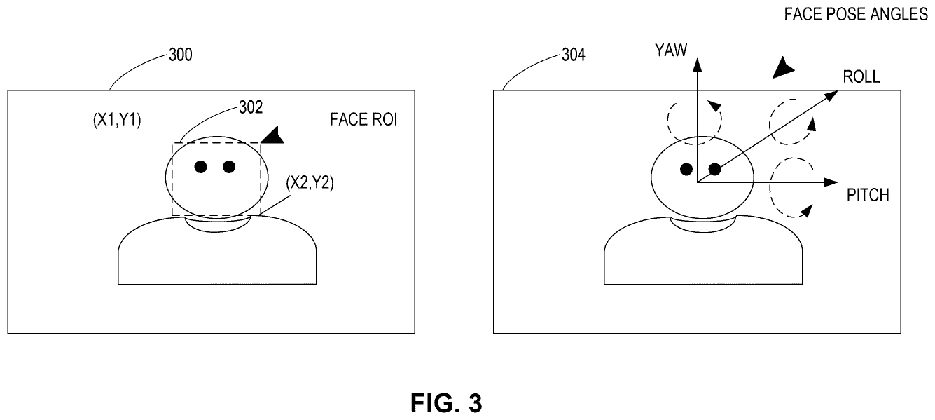

The example region analyzer circuitry 210 analyzes image data (e.g., raw image frames) to identify a face region present in the images. For example, the region analyzer circuitry 210 may utilize a face detection library, a neural network, deep learning, etc. to identify a face region present in the images. The example face region comprises coordinates that define a rectangle around a face present in an image. Alternatively, any other definition for a region may be utilized (e.g., a face region or any other type of region). Information collected for an example region may include information in addition to a position of the region in the image. For example, the region information may include characteristics of the object in the region (e.g., a face pose of a face in the region) may additional Example face region information is discussed in further detail in conjunction with FIGS. 3-5.

The example region analyzer circuitry 210 additionally determine statistics for the determined region. The example region analyzer circuitry 210 determines statistics for a difference between a region in a first frame and the corresponding region in a second frame. For example, the difference may indicate a change in the object in the region (e.g., a movement of a face). The region analyzer circuitry 210 of the illustrated example determines a F-norm value that is indicative of a difference between the region in two frames. For example, a difference between the region in two frames may be calculated as: diff=sqrt(x₂_{_{cur}}−x₁_{_{cur}})−(x₂_{_{ref}}−x₁_{_{ref}}))²+(y₂_{_{cur}}−y₁_{_{cur}})−(y₂_{_{ref}}−y₁_{_{ref}}))²) and F-norm may be calculated as

$$fnorm = Min ( \frac{diff}{sqrt ( {( {x}_{{2}_{ref}} - {x}_{{1}_{ref}} )}^{2} + {( {y}_{{2}_{ref}} - {y}_{{1}_{ref}} )}^{2} )} , max\_ fnorm )$$

where (x₁_{_{cur}}, y₁_{_{cur}}) is a left-top coordinate and (x₂_{_{cur}}, y₂_{_{cur}}) is a right-bottom coordinate of current face region, (x₁_{_{ref}}, y₁_{_{ref}}) is a left-top coordinate and (x₂_{_{ref}}, y₂_{_{ref}}) is a right-bottom coordinate of reference the face region in a previous focus success, and max_fnorm is the maximum acceptable variation of a face region which is tunable

While the example region analyzer circuitry 210 is described with respect to face regions, circuitry may be included to detect any type of region of interest. Alternatively, the region analyzer circuitry 210 may not be included in the autofocus circuitry 112 when another component (e.g., the devices 102A, 102B, 102C and/or the camera 106) perform face detection.

The example statistics analyzer circuitry 220 analyzes statistics determined by the region analyzer circuitry 210 to determine autofocus operations. For example, the statistics analyzer circuitry 220 may analyze the calculated F-norm to module a threshold for a scene change determination, may analyze the calculated F-norm to module a zone for successful autofocus, may analyze F-norm to module lens movement, etc. For example, to makes lens movement smoother for a user experience, the statistics analyzer may determine a lens movement step based on F-norm such as, for example,

$$final\_lens \_movement \_step = MAX ( min\_lens \_movement \_step , \frac{fnorm}{fnorm \_max} * lens\_movement \_step ) ,$$

where lens_movement_step is determined by applying an autofocus algorithm such as CDAF and min_lens_movement_step is a tunable parameter. If the F-norm value is nearly zero, the face region is similar to the reference face region and there is little face movement in depth. Therefore, the focus position is nearby, and a final lens movement step will be smaller for smoothness. If the F-norm value is large, there is large difference between a current face region and the reference face region and there is some face movement in depth. Therefore, the focus position is not nearby, and autofocus can use its lens movement step based on an autofocus algorithm such as, for example, CDAF to move the lens more quickly towards an in-focus position.

The example autofocus analyzer circuitry 230 performs an autofocus algorithm to determine how to control lens movement. For example, the autofocus analyzer circuitry 230 may perform contrast detection autofocus (CDAF), phase detection autofocus (PDAF), etc. For example, the autofocus analyzer circuitry 230 may perform an iteration of CDAF and/or PDAF and analyze the results to determine a focus state.

The example lens control circuitry 240 communicates lens movement information to the image capture device such as, for example, the devices 102A, 102B, 102C and/or the camera 106. For example, the lens control circuitry 240 may be communication circuitry to communicate a movement instruction and/or control system circuitry to control movement.

FIG. 3 illustrates an example image 300 in which a face region of interest 302 is defined by coordinates X1, Y1 to X2, Y2. Further illustrated is an example image 304 including indications of how a face pose may change in three dimensions: roll, pitch, and yaw.

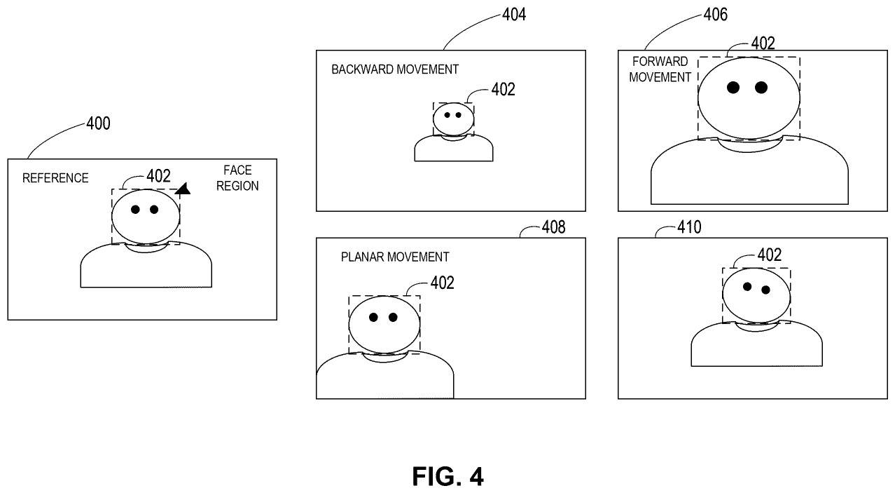

FIG. 4 illustrates examples of multiple movements of a face region 402 including the face moving backward (block 404), the face moving forward (block 406), planar movement of the head (block 408), and local head movement (block 410).

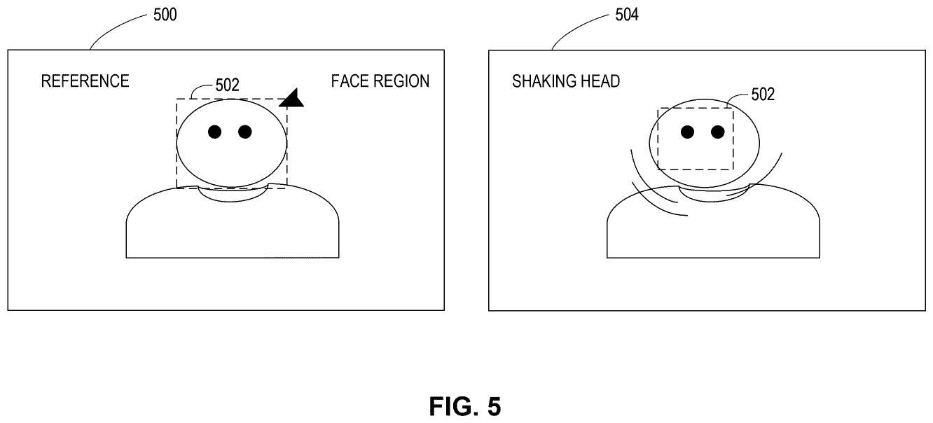

FIG. 5 illustrates an example of comparing head movement in a face region 502 between a reference image 500 and a current image 504.

Each of the movements in FIGS. 3-5 may trigger a new autofocus movement as the movement may cause the face region that starts in focus to become out of focus. However, in-place movements such as nodding or shaking a head may trigger autofocus when not desired. Accordingly, the methods and apparatus disclosed herein can make judgement that a focused head is shaking or nodding based on varying angles for continues frames. If there are face movements caused by nodding or shaking head a scene_change_threshold can be increased dynamically such as multiplication by fixed ratio.

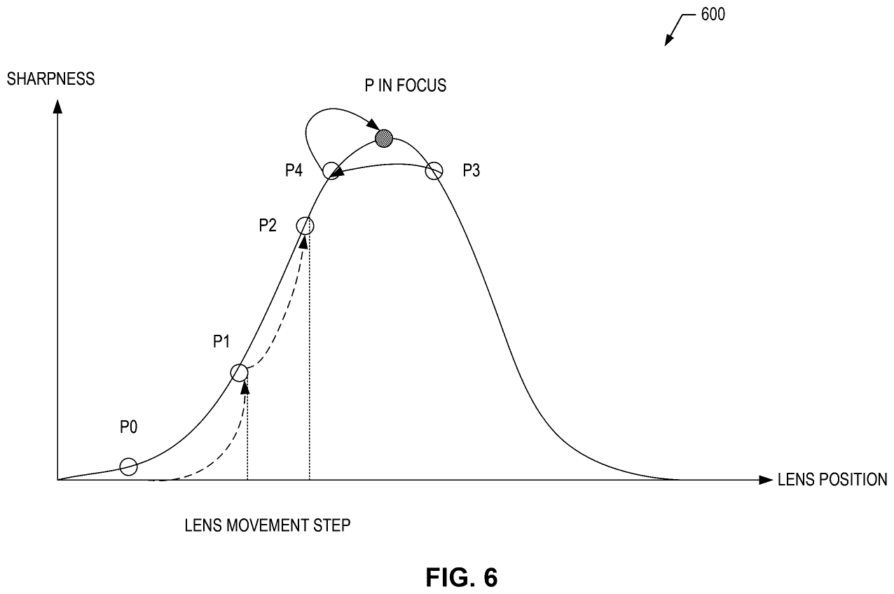

FIG. 6 is an illustration of an example approach 600 for finding a focus point (e.g., an optimal focus point). The hill-climbing approach 600 illustrated in FIG. 6 shows how a lens may be moved iteratively increasing sharpness with each iteration from P0-P2, but then decreases when moving to P3. Accordingly, the lens is moved back at P4 and then moved until P is in focus. While hill-climbing is one algorithm for locating a focus point other algorithms may be utilized with the methods and apparatus disclosed herein (e.g., adaptive searching, etc.).

While an example manner of implementing the autofocus circuitry 112 of FIG. 1 is illustrated in FIG. 2, one or more of the elements, processes, and/or devices illustrated in FIG. 2 may be combined, divided, re-arranged, omitted, eliminated, and/or implemented in any other way. Further, the example region analyzer circuitry 210, the example statistics analyzer circuitry 220, the example autofocus analyzer circuitry 230, the example lens control circuitry 240 and/or, more generally, the example autofocus circuitry 112 of FIG. 1, may be implemented by hardware alone or by hardware in combination with software and/or firmware. Thus, for example, any of the example region analyzer circuitry 210, the example statistics analyzer circuitry 220, the example autofocus analyzer circuitry 230, the example lens control circuitry 240 and/or, more generally, the example autofocus circuitry 112 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example autofocus circuitry 112 of FIG. 1 may include one or more elements, processes, and/or devices in addition to, or instead of, those illustrated in FIG. 2, and/or may include more than one of any or all of the illustrated elements, processes and devices.

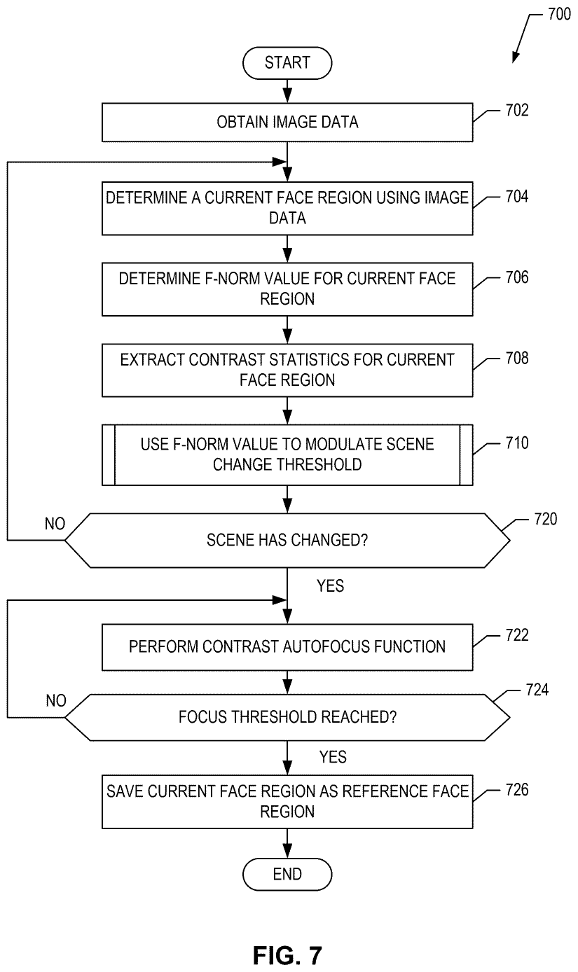

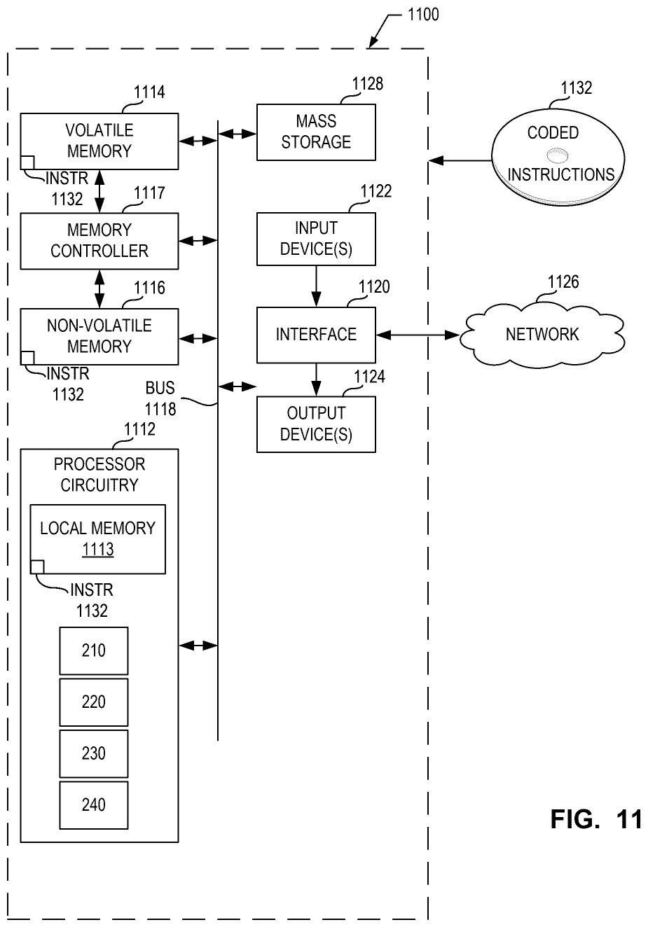

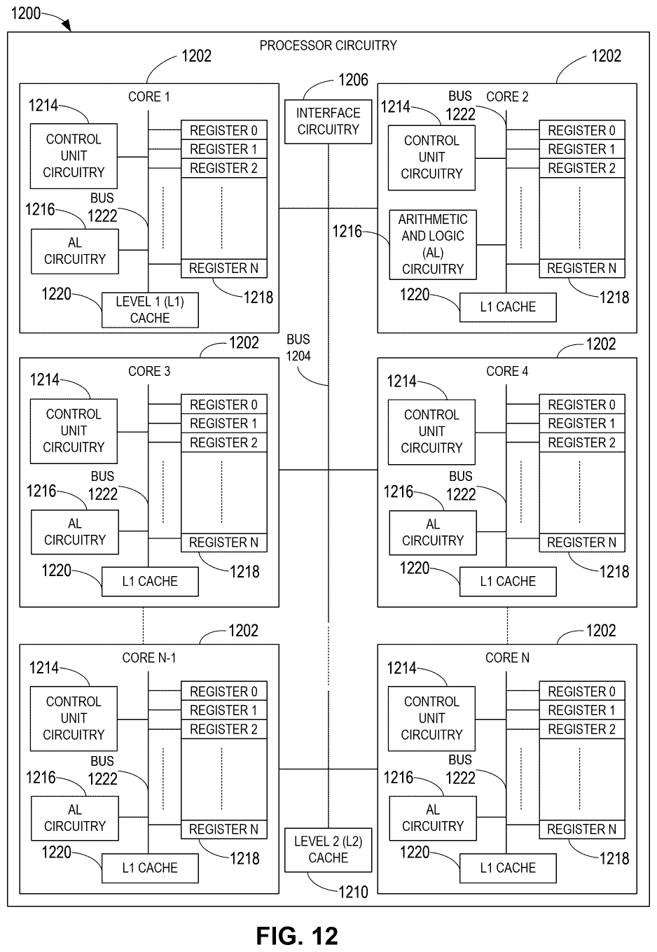

A flowchart representative of example machine readable instructions, which may be executed to configure processor circuitry to implement the autofocus circuitry 112 of FIG. 2, is shown in FIGS. 7-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 7-10, many other methods of implementing the example autofocus circuitry 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

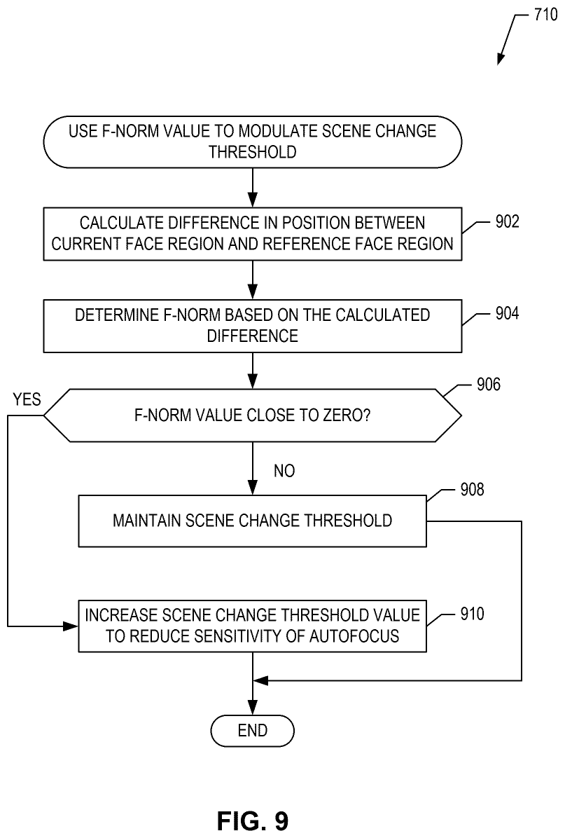

FIG. 7 is a flowchart representative of example machine readable instructions and/or example operations 700 that may be executed and/or instantiated by processor circuitry to control autofocus of an image capture device utilizing CDAF. The machine readable instructions and/or the operations 700 of FIG. 7 begin at block 702, at which the region analyzer circuitry 210 obtains image data (e.g., raw image frames). The example region analyzer circuitry 210 determines a current face region using the image data (block 704). In some examples, the region analyzer circuitry obtains the detected face region a face detection library that is applied to stream image data output from an image signal processing hardware. The detected face region may include coordinates for a region, a detected face angle, etc. The example region analyzer circuitry 210 determines a difference measurement (e.g., F-norm value) for current face region (block 706). The example region analyzer circuitry 210 extracts contrast statistics for the current face region (block 708). The example autofocus analyzer circuitry 230 utilizes the difference measurement (e.g., F-norm value) to modulate a scene change threshold (block 710). Further detail of the modulation is described in conjunction with FIG. 9.

The example autofocus analyzer circuitry 230 then determines if the scene has changed based on the threshold (block 720). When the scene has not changed, control returns to block 704 returns to block 704 to continue analyzing for a scene change. When the scene has changed, the example autofocus analyzer circuitry 230 performs a contrast autofocus iteration (e.g., CDAF) (block 722). The example autofocus analyzer circuitry 230 then determines if the focus threshold has been reached (block 724). If the autofocus threshold has not been reached, control returns to block 722 to perform another contrast autofocus function. If the autofocus threshold has been reached, the example autofocus analyzer circuitry 230 saves the current face region as a reference face region (block 726). The region analyzer circuitry 210 may additionally save the current face region as a reference face region. The process 700 may then end or control may return to block 702 to receive further image data and analyze for a scene change.

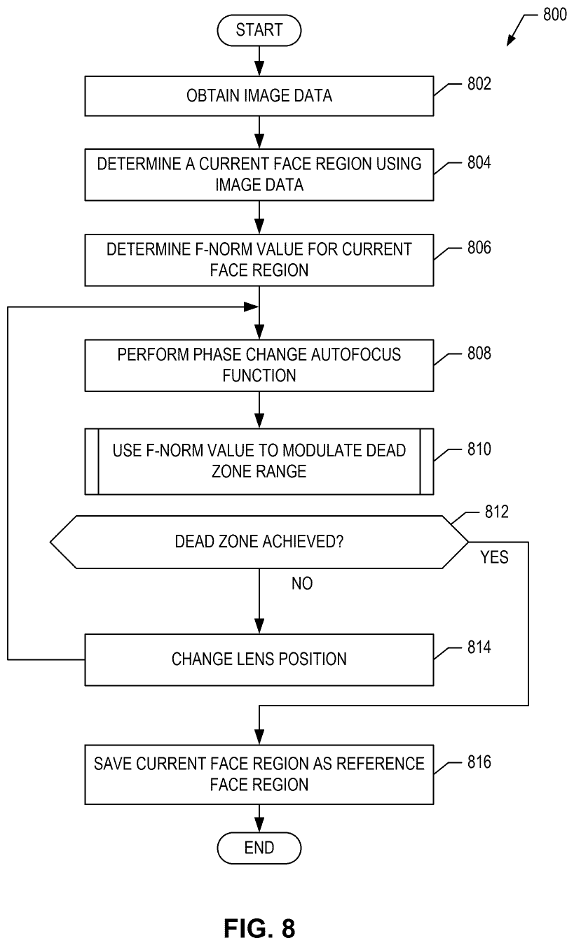

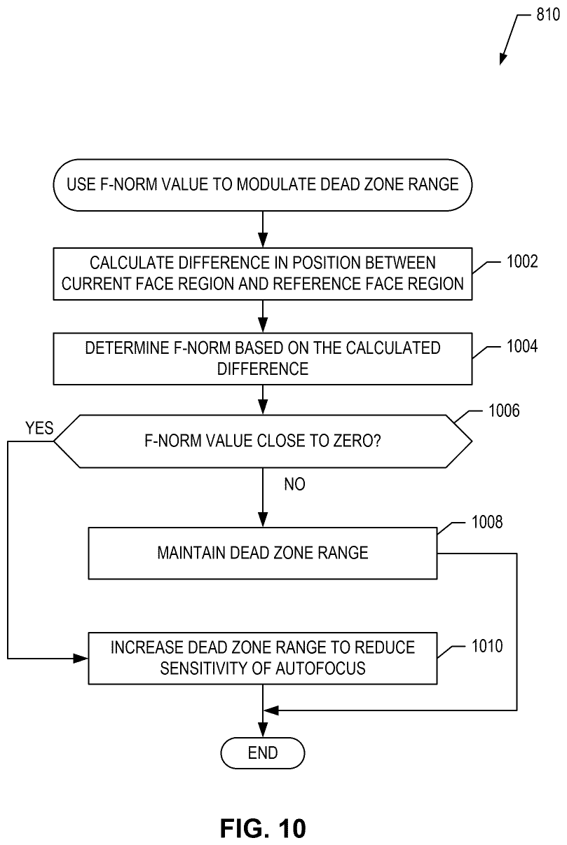

FIG. 8 is a flowchart representative of example machine readable instructions and/or example operations 800 that may be executed and/or instantiated by processor circuitry to control autofocus of an image capture device utilizing PDAF. The example of FIG. 8 utilizes phase detection autofocus as opposed to the contrast detection autofocus utilized in FIG. 8. The machine readable instructions and/or the operations 800 of FIG. 8 begin at block 802 at which the region analyzer circuitry 210 obtains image data (e.g., raw image frames). The example region analyzer circuitry 210 determines a current face region using the image data (block 804). The example region analyzer circuitry 210 determines a difference measurement (e.g., F-norm value) for current face region (block 806). The example region analyzer circuitry 210 performs phase detection autofocus functionality (block 808). The example autofocus analyzer circuitry 230 utilizes the difference measurement (e.g., F-norm value) to modulate a dead zone range for the autofocus (block 810). Further detail of the modulation is described in conjunction with FIG. 10.

The example autofocus analyzer circuitry 230 then determines if a dead zone has been achieved (block 812). When the dead zone has not been achieved, the lens control circuitry 240 directs adjustment of the lens position and control returns to block 808 to continue analysis. When the dead zone has been achieved, the example region analyzer circuitry 210 stores the current face region as a reference face region.

FIG. 9 is a flowchart representative of example machine readable instructions and/or example operations 900 that may be executed and/or instantiated by processor circuitry to implement block 710 of FIG. 7. The machine readable instructions and/or the operations 710 of FIG. 9 begin at block 902 at which the statistics analyzer circuitry 220 calculates a difference in position between the current face region and a reference face region. The example region analyzer circuitry 210 determines an F-norm value based on the calculated difference (block 904). The example statistics analyzer circuitry 220 determines if the F-norm value is sufficiently close to zero (block 906). When the F-norm value is not sufficiently close to zero, the example statistics analyzer circuitry 220 maintains the existing scene change threshold (block 908) and control returns to block 712 of FIG. 7. When the F-norm value is sufficiently close to zero, the statistics analyzer circuitry 220 increases the scene change threshold value to reduce the sensitivity of autofocus (block 910) and control returns to block 712 of FIG. 7. For example, the scene change threshold may be calculated as:

$$scene\_change \_threshold = ( 1 - \frac{fnorm}{max\_ fnorm} ) * max\_scene \_change \_threshold ,$$

where max_scene_change_threshold is a max scene change threshold parameter which is tunable. If the F-norm value is nearly zero, it means the face region is similar as reference face region in success autofocus previously and there is little face movement in depth. Therefore, the scene change threshold can be increased to reduce sensitivity of autofocus, and autofocus can be stable and avoid repeat response. If the F-norm value is large (e.g., greater than 0.15 but less than a maximum F-norm value), there is a large difference between current face region and reference face region and there is some face movement in depth. Therefore, the scene change threshold can be decreased to improve sensitivity of autofocus, and an autofocus response can be triggered easily. As used herein, the F-norm value is utilized to modulate scene change threshold, but F-form can also be utilized to modulate a blur function or similar characteristic.

FIG. 10 is a flowchart representative of example machine readable instructions and/or example operations 1000 that may be executed and/or instantiated by processor circuitry to implement block 810 of FIG. 8. The machine readable instructions and/or the operations 810 of FIG. 10 begin at block 1002 at which the statistics analyzer circuitry 220 calculates a difference in position between the current face region and a reference face region. The example region analyzer circuitry 210 determines an F-norm value based on the calculated difference (block 1004). The example statistics analyzer circuitry 220 determines if the F-norm value is sufficiently close to zero (block 1006). When the F-norm value is not sufficiently close to zero, the example statistics analyzer circuitry 220 maintains the existing dead zone range (block 1008) and control returns to block 812 of FIG. 8. When the F-norm value is sufficiently close to zero, the statistics analyzer circuitry 220 increases the dead zone range to reduce the sensitivity of autofocus (block 1010) and control returns to block 812 of FIG. 8. For example, the dead zone may be calculated as

$$dead\_zone = ( 1 - \frac{fnorm}{fnorm\_max} ) * max\_dead \_zone ,$$

where max_dead_zone is a tunable dead zone parameter. If the F-norm value is nearly zero, the face region is similar to the reference face region (e.g., from a previous autofocus) and there is little face movement in depth. Therefore, the dead zone threshold can be increased to reduce a sensitivity of autofocus, and autofocus can be stable and avoid repeat response. If the F-norm value is large (e.g., greater than 0.15 but less than a maximum F-norm value), there is large difference between current face region and reference face region and there is some face movement in depth. Therefore, the dead zone can be decreased to improve sensitivity of autofocus, and autofocus response for the face can be triggered easily.

FIG. 11 is a block diagram of an example processor platform 1100 structured to execute and/or instantiate the machine readable instructions and/or the operations of FIGS. 7-10 to implement the autofocus circuitry 112 of FIG. 1. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example region analyzer circuitry 210, the example statistics analyzer circuitry 220, the example autofocus analyzer circuitry 230, and the example lens control circuitry 240.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIGS. 7-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowchart of FIGS. 7-10 to effectively instantiate the circuitry of FIG. 2 [er diagram] as logic circuits to perform the operations corresponding to those machine readable instructions. In some such examples, the circuitry of FIG. 2 [er diagram] is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIGS. 7-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

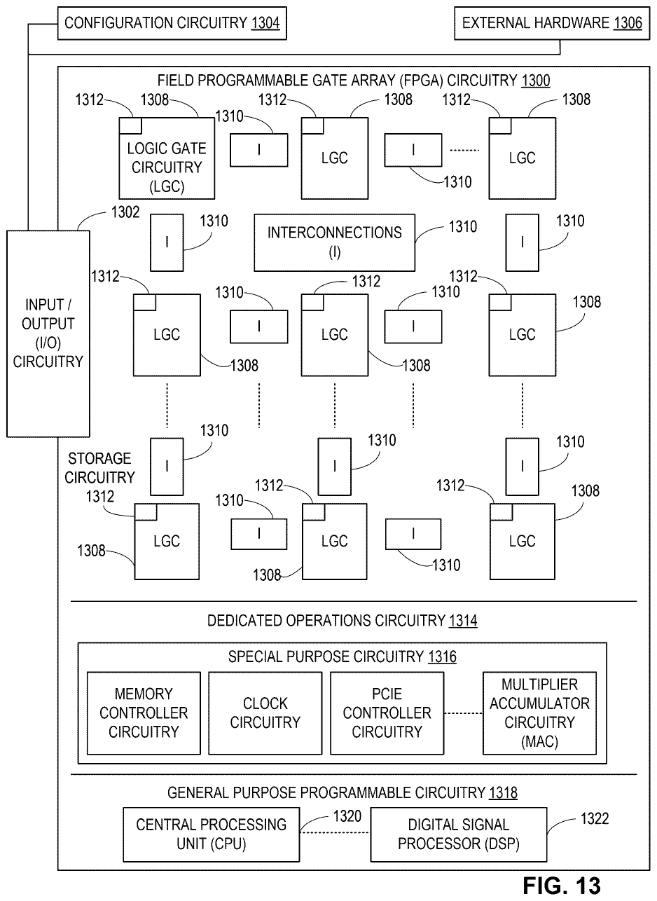

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowchart of FIGS. 7-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIGS. 7-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowchart of FIGS. 7-10. As such, the FPGA circuitry 1300 may be structured to effectively instantiate some or all of the machine readable instructions of the flowchart of FIGS. 7-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 7-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 7-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowchart of FIGS. 7-10 may be executed by one or more of the cores 1202 of FIG. 12, a second portion of the machine readable instructions represented by the flowchart of FIGS. 7-10 may be executed by the FPGA circuitry 1300 of FIG. 13, and/or a third portion of the machine readable instructions represented by the flowchart of FIGS. 7-10 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

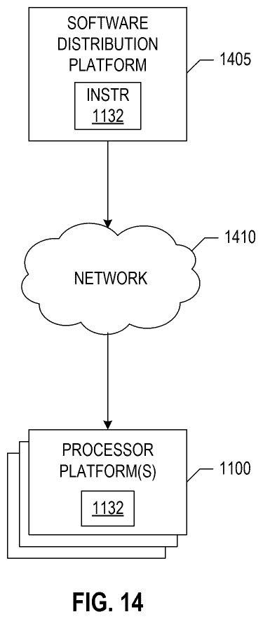

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 7-10, as described above. The one or more servers of the example software distribution platform 1405 are in communication with an example network 1410, which may correspond to any one or more of the Internet and/or any of the example networks 104 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 7-10, may be downloaded to the example processor platform 1100, which is to execute the machine readable instructions 1132 to implement the autofocus server 112. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that control autofocus for an image capture device. Disclosed systems, methods, apparatus, and articles of manufacture improve the efficiency of using a computing device by more quickly and accurately bringing an object and/or region into focus in an image capture device. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for autofocus for image capture systems are disclosed herein. Further examples and combinations thereof include the following:

Example 1 includes a computer readable medium comprising instructions that, when executed, cause a machine to at least obtain face information including a current face region from a face detection library, calculate a region difference metric between the current face region and a reference face region, extract statistics of the current face region, control at least one of a scene change judgement or a dead zone to determine whether to trigger autofocus iterations, perform an autofocus iteration with lens movement controlled based on the region difference metric, and save an in-focus face region resulting from the autofocus iteration as the reference face region.

Example 2 includes the computer readable medium of example 1, wherein the instructions, when executed, cause the machine to determine a scene change threshold based on the region difference metric.

Example 3 includes the computer readable medium of example 2, wherein the instructions, when executed, cause the machine to determine whether a further autofocus iteration is to be performed based on the scene change threshold.

Example 4 includes the computer readable medium of example 1, wherein the instructions, when executed, cause the machine to determine the difference based on a difference between coordinates of the current face region and coordinates of the reference face region.

Example 5 includes the computer readable medium of example 1, wherein the instructions, when executed, cause the machine to control sensitivity of the autofocus iterations based on the difference.

Example 6 includes the computer readable medium of example 1, wherein the instructions, when executed, cause the machine to determine if the current face region is in focus based a dead zone calculated based on the difference.

Example 7 includes the computer readable medium of example 1, wherein the instructions, when executed, cause the machine to, when the difference indicates that the current face region is different than the reference face region, perform another autofocus iteration to move the lens, and determine if the current face region is in focus.

Example 8 includes the computer readable medium of example 6, wherein the instructions, when executed, cause the machine to store the current face region as the reference face region when the current face region is determined to be in focus.

Example 9 includes the computer readable medium of example 6, wherein the instructions, when executed, cause the machine to perform a contrast detection autofocus iteration when the difference metric indicates that the current face region is different from the reference face region.

Example 10 includes the computer readable medium of example 6, wherein the instructions, when executed, cause the machine to perform a phase detection autofocus iteration when the region difference metric indicates that the current face region is different from the reference face region.

Example 11 includes the computer readable medium of example 1, wherein the face information includes a face pose.

Example 12 includes an apparatus to control autofocus, the apparatus comprising at least one memory, machine readable instructions, and processor circuitry to at least one of instantiate or execute the machine readable instructions to obtain face information including a current face region from a face detection library, calculate a region difference metric between the current face region and a reference face region, extract statistics of the current face region, control at least one of a scene change judgement or a dead zone to determine whether to trigger autofocus iterations, perform an autofocus iteration with lens movement controlled based on the region difference metric, and save an in-focus face region resulting from the autofocus iteration as the reference face region.

Example 13 includes the apparatus of example 12, wherein the processor circuitry is to determine a scene change threshold based on the region difference metric.

Example 14 includes the apparatus of example 13, wherein the processor circuitry is to determine whether a further autofocus iteration is to be performed based on the scene change threshold.

Example 15 includes the apparatus of example 12, wherein the processor circuitry is to determine the difference based on a difference between coordinates of the current face region and coordinates of the reference face region.

Example 16 includes the apparatus of example 12, wherein the processor circuitry is to control sensitivity of the autofocus iterations based on the difference.

Example 17 includes the apparatus of example 12, wherein the processor circuitry is to determine if the current face region is in focus based a dead zone calculated based on the difference.

Example 18 includes the apparatus of example 12, wherein the processor circuitry is to, when the difference indicates that the current face region is different than the reference face region, perform another autofocus iteration to move the lens, and determine if the current face region is in focus.

Example 19 includes the apparatus of example 17, wherein the processor circuitry is to store the current face region as the reference face region when the current face region is determined to be in focus.

Example 20 includes the apparatus of example 17, wherein the processor circuitry is to perform a contrast detection autofocus iteration when the difference metric indicates that the current face region is different from the reference face region.

Example 21 includes the apparatus of example 17, wherein the processor circuitry is to perform a phase detection autofocus iteration when the region difference metric indicates that the current face region is different from the reference face region.

Example 22 includes the apparatus of example 12, wherein the face information includes a face pose.

Example 23 includes a method to control autofocus, the method comprising obtaining face information including a current face region from a face detection library, calculating a region difference metric between the current face region and a reference face region, extracting statistics of the current face region, controlling at least one of a scene change judgement or a dead zone to determine whether to trigger autofocus iterations, performing an autofocus iteration with lens movement controlled based on the region difference metric, and saving an in-focus face region resulting from the autofocus iteration as the reference face region.

Example 24 includes the method of example 23, further comprising determining a scene change threshold based on the region difference metric.

Example 25 includes the method of example 24, further comprising determining whether a further autofocus iteration is to be performed based on the scene change threshold.

Example 26 includes the method of example 23, further comprising determining the difference based on a difference between coordinates of the current face region and coordinates of the reference face region.

Example 27 includes the method of example 23, further comprising controlling sensitivity of the autofocus iterations based on the difference.

Example 28 includes the method of example 23, further comprising determining if the current face region is in focus based a dead zone calculated based on the difference.

Example 29 includes the method of example 23, further comprising, when the difference indicates that the current face region is different than the reference face region, performing another autofocus iteration to move the lens, and determining if the current face region is in focus.

Example 30 includes the method of example 28, further comprising storing the current face region as the reference face region when the current face region is determined to be in focus.

Example 31 includes the method of example 28, further comprising performing a contrast detection autofocus iteration when the difference metric indicates that the current face region is different from the reference face region.

Example 32 includes the method of example 28, further comprising performing a phase detection autofocus iteration when the region difference metric indicates that the current face region is different from the reference face region.

Example 33 includes the method of example 23, wherein the face information includes a face pose.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A computer readable medium comprising instructions that, when executed, cause a machine to at least:
obtain face information including a current face region from a face detection library;
calculate a region difference metric between the current face region and a reference face region;
extract statistics of the current face region;
control at least one of a scene change judgement or a dead zone to determine whether to trigger autofocus iterations;
perform an autofocus iteration with lens movement controlled based on the region difference metric; and
save an in-focus face region resulting from the autofocus iteration as the reference face region.

2. The computer readable medium of claim 1, wherein the instructions, when executed, cause the machine to determine a scene change threshold based on the region difference metric.

3. The computer readable medium of claim 2, wherein the instructions, when executed, cause the machine to determine whether a further autofocus iteration is to be performed based on the scene change threshold.

4. The computer readable medium of claim 1, wherein the instructions, when executed, cause the machine to determine the difference based on a difference between coordinates of the current face region and coordinates of the reference face region.

5. The computer readable medium of claim 1, wherein the instructions, when executed, cause the machine to control sensitivity of the autofocus iterations based on the difference.

6. The computer readable medium of claim 1, wherein the instructions, when executed, cause the machine to determine if the current face region is in focus based a dead zone calculated based on the difference.

7. The computer readable medium of claim 1, wherein the instructions, when executed, cause the machine to, when the difference indicates that the current face region is different than the reference face region:
perform another autofocus iteration to move the lens; and
determine if the current face region is in focus.

8. The computer readable medium of claim 6, wherein the instructions, when executed, cause the machine to store the current face region as the reference face region when the current face region is determined to be in focus.

9. The computer readable medium of claim 6, wherein the instructions, when executed, cause the machine to perform a contrast detection autofocus iteration when the difference metric indicates that the current face region is different from the reference face region.

10. The computer readable medium of claim 6, wherein the instructions, when executed, cause the machine to perform a phase detection autofocus iteration when the region difference metric indicates that the current face region is different from the reference face region.

11. The computer readable medium of claim 1, wherein the face information includes a face pose.

12. An apparatus to control autofocus, the apparatus comprising:
at least one memory;
machine readable instructions; and
processor circuitry to at least one of instantiate or execute the machine readable instructions to:
obtain face information including a current face region from a face detection library;
calculate a region difference metric between the current face region and a reference face region;
extract statistics of the current face region;
control at least one of a scene change judgement or a dead zone to determine whether to trigger autofocus iterations;
perform an autofocus iteration with lens movement controlled based on the region difference metric; and
save an in-focus face region resulting from the autofocus iteration as the reference face region.

13. The apparatus of claim 12, wherein the processor circuitry is to determine a scene change threshold based on the region difference metric.

14. The apparatus of claim 13, wherein the processor circuitry is to determine whether a further autofocus iteration is to be performed based on the scene change threshold.

15. The apparatus of claim 12, wherein the processor circuitry is to determine the difference based on a difference between coordinates of the current face region and coordinates of the reference face region.

16. The apparatus of claim 12, wherein the processor circuitry is to control sensitivity of the autofocus iterations based on the difference.

17. The apparatus of claim 12, wherein the processor circuitry is to determine if the current face region is in focus based a dead zone calculated based on the difference.

18. The apparatus of claim 12, wherein the processor circuitry is to, when the difference indicates that the current face region is different than the reference face region:
perform another autofocus iteration to move the lens; and
determine if the current face region is in focus.

19-22. (canceled)

23. A method to control autofocus, the method comprising:
obtaining face information including a current face region from a face detection library;
calculating, via execution of instructions by a programmable circuit, a region difference metric between the current face region and a reference face region;
extracting statistics of the current face region;
controlling at least one of a scene change judgement or a dead zone to determine whether to trigger autofocus iterations;
performing an autofocus iteration with lens movement controlled based on the region difference metric; and
saving an in-focus face region resulting from the autofocus iteration as the reference face region.

24. The method of claim 23, further including determining a scene change threshold based on the region difference metric.

25-33. (canceled)
